(19) United States
(12) Patent Application Publication
(10) Pub. No.: US 2023/0096359 A1
(43) Pub. Date: Mar. 30, 2023

(54) Grooming Device

(71) Applicant: Manscaped, LLC, San Diego, CA (US)

(72) Inventors: Anh Hao TRAN, Las Vegas, NV (US); Maxwell WONG, San Diego, CA (US); Edilbert Neri ABILLAR, Vista, CA (US); Christopher WOO, San Diego, CA (US); Mike HIDOCK, San Diego, CA (US); Ian KOVACEVICH, Carlsbad, CA (US); Kassie BETTS, San Diego, CA (US)

(21) Appl. No.: 17/442,785

(22) PCT Filed: Mar. 30, 2021
(86) PCT No.: PCT/US2021/024996

§ 371 Date: Sep. 24, 2021

Related U.S. Application Data
(60) Provisional application No. 63/149,197, filed on Feb. 12, 2021.
(60) Provisional application No. 63/009,934, filed on Apr. 14, 2020.

(51) Int. Cl. B26B 19/38; B26B 19/06

(52) U.S. Cl. CPC B26B 19/3846; B26B 19/06

(57) ABSTRACT

A grooming device having a base plate, a reciprocating plate, and a biasing mechanism. The base plate includes a plurality of grooves configured for guiding hair into a plurality of grooves of the reciprocating plate. The grooves of the reciprocating plate are disposed in sliding abutment with the grooves of the base plate and are configured as cutting edges for shearing or cutting the hair extending through the grooves of the base plate.

### CROSS-REFERENCE TO RELATED APPLICATIONS

This application claims the benefit of U.S. Provisional Application No. 63/009,934, filed Apr. 14, 2020, and U.S. Provisional Application No. 63/149,197, filed Feb. 12, 2021, which are herein incorporated by reference in their entirety.

### TECHNICAL FIELD

The instant disclosure pertains to a grooming device. More particularly, the disclosure is directed to an electric grooming device.

### BACKGROUND

Conventional grooming devices include a monolithic base plate defined at least in part by a plurality of grooves, and a reciprocating plate defined at least in part by a plurality of grooves. The monolithic base plate and the reciprocating plate are disposed adjacent each other such that at least the grooves of the reciprocating plate are adjacent the grooves of the monolithic base plate. In some grooming devices, the grooves of the reciprocating plate are in sliding abutment with the grooves of the monolithic base plate. The grooves of the reciprocating plate are configured for shearing or cutting hair extending through the grooves of the monolithic base plate. In use, the surface of the monolithic base plate opposite the surface facing the reciprocating plate is placed in sliding engagement with the surface being groomed such that hair protruding from the surface being groomed extend through the grooves of the monolithic base plate and into the grooves of the reciprocating plate such that hair is sheared or cut when a reciprocating mechanism operates the reciprocating plate.

One drawback of such conventional grooming devices on sensitive, loose, and/or bumpy skin is that a user's skin can extend through the grooves of the monolithic base plate and get pinched, cut, and/or nicked in the grooves of the reciprocating plate. These deleterious conditions are not alleviated by using less pressure or other techniques with the grooming device. Additionally, the grooves of the reciprocating plate on the side opposite the side facing the monolithic base plate are generally exposed or open and are therefore hazardous in that an object, for example a user's finger, can touch and get pinched, cut, and/or nicked by the grooves of the reciprocating plate.

### SUMMARY

In some embodiments, a grooming device includes a monolithic base plate, a reciprocating plate, and a reciprocating mechanism. In some embodiments, the monolithic base plate is defined at least in part by opposing first end and second end, a cavity defined at least in part by an arcuate section of the monolithic base plate proximate the first end thereof, and a plurality of grooves disposed along at least a portion of the arcuate section. In some embodiments, the monolithic base plate from the first end to the second end is one integral piece. In some embodiments, the monolithic base plate prevents a user's sensitive, loose, and/or bumpy skin and/or other body parts from extending through the grooves of the monolithic base plate and thus prevents pinching, cutting, and/or nicking of the skin and/or body part in the grooves of the reciprocating plate. In some embodiments, the reciprocating plate is defined at least in part by a first end having a plurality of grooves extending into the cavity of the monolithic base plate, and a second end opposite the first end. In some embodiments, the reciprocating mechanism is operatively coupled to the reciprocating plate. In some embodiments, attachments may be placed on the monolithic base plate to increase the distance between the monolithic base plate and the skin to allow for clipping of hair shafts at different lengths. In some embodiments, the hair is clipped at a chosen distance from the skin, i.e., for cutting the hairs to a desired length. In some embodiments, the hair is clipped at a length equal to or at the surface of the skin. In some embodiments, the hair in sensitive areas is clipped, without nicking the user's skin or causing painful razor burn, as a result of the grooves of the reciprocating plate not directly touching the skin thereby allowing trimming of long hair follicles.

In some embodiments, a grooming device includes a monolithic base plate, a reciprocating plate, a biasing mechanism, and a reciprocating mechanism. In some embodiments, the monolithic base plate is defined at least in part by opposing first end and second end, a cavity defined at least in part by an arcuate section of the monolithic base plate proximate the first end thereof, and a plurality of grooves disposed along at least a portion of the arcuate section. In some embodiments, the reciprocating plate is defined at least in part by a first end having a plurality of grooves extending into the cavity of the monolithic base plate, and a second end opposite the first end. In some embodiments, the biasing mechanism is configured for retaining the first end of the reciprocating plate in sliding abutment within or in close proximity to the cavity of the monolithic base plate. In some embodiments, the reciprocating mechanism is operatively coupled to the reciprocating plate.

### BRIEF DESCRIPTION OF THE DRAWINGS

FIG. 1 is a perspective view illustrating non-limiting exemplary embodiments of some of the primary components inside an embodiment of a grooming device of the instant disclosure;

FIG. 2 is a perspective view of a non-limiting exemplary embodiment of a monolithic base plate for a grooming device of the instant disclosure;

FIG. 3 is a perspective view of a non-limiting exemplary embodiment of a reciprocating plate for a grooming device of the instant disclosure;

FIG. 4 is a perspective view illustrating non-limiting exemplary embodiments of a monolithic base plate and a reciprocating plate coupled to each other for a grooming device of the instant disclosure;

FIG. 5 is a side view of the coupled monolithic base plate and reciprocating plate illustrated in FIG. 4;

FIG. 6 is a close-up perspective view of the coupled monolithic base plate and reciprocating plate illustrated in FIG. 4;

FIG. 7 is a side view illustrating additional non-limiting exemplary embodiments of a monolithic base plate and a reciprocating plate for a grooming device of the instant disclosure;

FIG. 8 is a side view illustrating additional non-limiting exemplary embodiments of a monolithic base plate and a reciprocating plate for a grooming device of the instant disclosure;

FIG. 9 is a side view illustrating additional non-limiting exemplary embodiments of a monolithic base plate and a reciprocating plate for a grooming device of the instant disclosure;

FIG. 10 is a side view illustrating additional non-limiting exemplary embodiments of a monolithic base plate and a reciprocating plate for a grooming device of the instant disclosure;

FIG. 11 is a side view illustrating additional non-limiting exemplary embodiments of a monolithic base plate and a reciprocating plate for a grooming device of the instant disclosure;

FIG. 12 is a side view illustrating additional non-limiting exemplary embodiments of a monolithic base plate and a reciprocating plate for a grooming device of the instant disclosure;

FIG. 13 illustrates a grooved end of a non-limiting exemplary embodiment of a reciprocating plate disposed within a cavity of a non-limiting exemplary embodiment of a monolithic base plate for a grooming device of the instant disclosure;

FIG. 14 illustrates an exemplary angle of a non-limiting exemplary embodiment of a cavity defined by an arcuate section of a monolithic base plate and an exemplary angle at a cutting end/edge of a reciprocating plate for a grooming device of the instant disclosure; and

FIG. 15 is a perspective view illustrating alternate non-limiting exemplary embodiments of some of the primary components inside an alternate embodiment of a grooming device of the instant disclosure.

### DETAILED DESCRIPTION

One or more non-limiting exemplary embodiments are disclosed herein with reference to the accompanying drawings, wherein like numerals indicate like, but not necessarily identical, elements. It should be clearly understood that the embodiments described with reference to the drawings are merely exemplary in that any one or more of them may be implemented in alternative manner as may become apparent to a person of ordinary skills. The figures are not necessarily to scale. Specific structural and/or functional features and details disclosed herein are not to be construed as limiting but should rather be treated as a basis for teaching one of ordinary skills. There is no intent, implied or otherwise, to limit the disclosure in any way, shape or form to the embodiments illustrated and described herein. Accordingly, all variants for providing structures and/or functionalities similar to those described herein for the embodiments are considered as being within the metes and bounds of the instant disclosure.

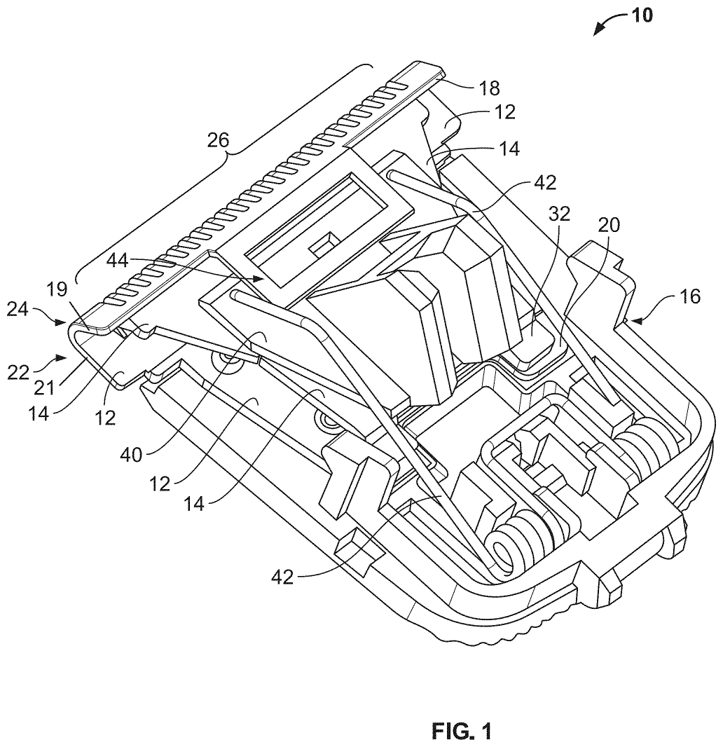

FIG. 1 is a perspective view of non-limiting exemplary embodiments of some of the primary components inside an embodiment of a grooming device 10 of the instant disclosure. In some embodiments, the grooming device 10 includes a monolithic base plate 12 (e.g., a blade guard), a reciprocating plate 14 (e.g., a cutting blade), and a biasing mechanism 16. As further described herein below, some embodiments of the grooming device 10 do not have a biasing mechanism such as, for example, biasing mechanism 16. In some embodiments, the monolithic base plate 12 is defined at least in part by opposing first end 18 and second end 20, respectively, a first portion 19, a second portion 21, and an arcuate section 24. In some embodiments, the first portion 19, the arcuate section 24, and the second portion 21 together define a cavity 22. In some embodiments, the monolithic base plate 12 includes a plurality of grooves 26 disposed along at least a portion of the arcuate section 24. In some embodiments, the monolithic base plate 12 includes a tab or an overhang 44 extending away from the first end 18. Although not shown, the grooming device 10 includes a reciprocating mechanism operatively coupled to and configured for reciprocating the reciprocating plate 14 as is well known in the art. In some embodiments, the reciprocating mechanism is operatively coupled to the reciprocating plate 14. In some embodiments, the reciprocating mechanism is operatively coupled to the biasing mechanism 16 which is coupled to the reciprocating plate 14. In some embodiments, the biasing mechanism 16 includes a biasing plate 40 coupled to the reciprocating plate 14 and at least one biasing element 42. In some embodiments, the reciprocating plate 14 is defined at least in part by opposing first end 30 (not shown) and second end 32, respectively.

As used herein, “monolithic” refers to a continuous piece of fused material. Examples of material include, but are not limited to, metal (e.g., stainless steel) and/or may be a coated metal and/or ceramic material, as desired. For purposes of clarity, a removable plastic guard connected to a metal/ceramic base plate is not a monolithic base plate as defined herein. In some embodiments, the material is formed by processes including, but not limited to, casting, machine molding, and/or three-dimensional printing.

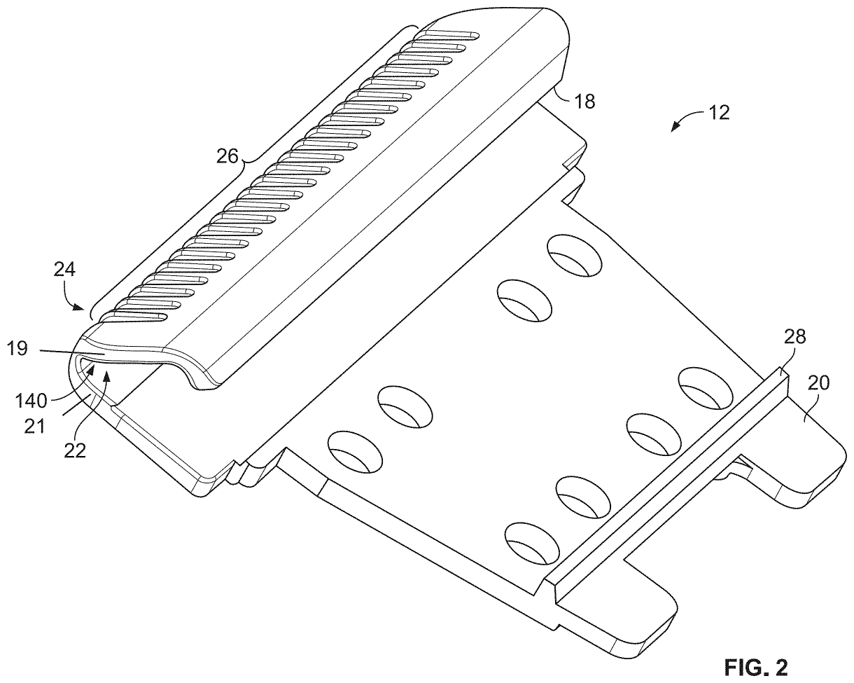

FIG. 2 is a perspective view of a non-limiting exemplary embodiment of the monolithic base plate 12. In some embodiments, the monolithic base plate 12 is defined at least in part by opposing first end 18 and second end 20, respectively, a first portion 19, a second portion 21, and an arcuate section 24. In some embodiments, the first portion 19 extends from the first end 18 to the arcuate section 24. In some embodiments, the second portion 21 extends from the second end 20 to the arcuate section 24. In some embodiments, the first portion 19, the arcuate section 24, and the second portion 21 together define a cavity 22. In some embodiments, the cavity 22 includes an inside surface 140. In some embodiments, the monolithic base plate 12 includes a cavity 22 defined at least in part by an arcuate section 24 proximate the first end 18. In some embodiments, the monolithic base plate 12 includes a plurality of grooves 26 disposed along at least a portion of the arcuate section 24. In some embodiments, the monolithic base plate 12 includes a rail 28 disposed proximate the second end 20.

In some embodiments, the thicknesses of the monolithic base plate 12 and reciprocating plate 14 may be of any thickness sufficient to support structural needs and/or reliability concerns for the overall structure. In some embodiments, different thicknesses of the monolithic base plate 12 and reciprocating plate 14 are contemplated as being within the scope of the present disclosure, as is the use of different materials for the monolithic base plate 12 and reciprocating plate 14. In some embodiments, for example, and not by way of limitation, the monolithic base plate 12 and/or reciprocating plate 14 may be an austenitic stainless steels, i.e., having a high chromium content compared to other steel alloys, giving them a higher resistance to corrosion. In some embodiments, for example, and not by way of limitation, the monolithic base plate 12 and/or reciprocating plate 14 may be a ferritic stainless steel to use the magnetic properties thereof, or may be a martensitic stainless steel to increase corrosion resistance, raise tensile strength, and increase the hardness of the monolithic base plate 12 and/or reciprocating plate 14. In some embodiments, for example, and not by way of limitation, the reciprocating plate 14 may be a ceramic material for longer blade life. In some embodiments, for example, and not by way of limitation, the monolithic base plate 12 may also be the same material as the reciprocating plate 14, if desired.

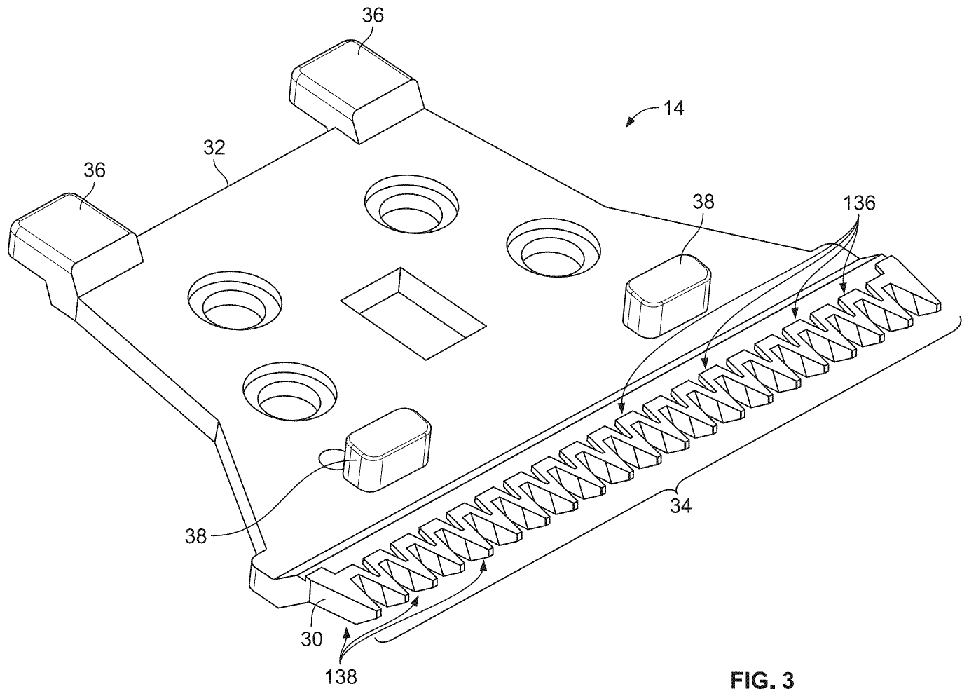

FIG. 3 is a perspective view of a non-limiting exemplary embodiment of the reciprocating plate 14. In some embodiments, the reciprocating plate 14 is defined at least in part by opposing first end 30 and second end 32, respectively. In some embodiments, the reciprocating plate 14 includes a plurality of grooves 34 disposed along at least a portion of the first end 30 of the reciprocating plate 14. Accordingly, the reciprocating plate 14 is considered having at least two distinct “cutting surfaces” or “cutting planes” 136 and 138 defined at least in part by the grooves 34 configured as cutting edges. It will be appreciated that the at least two distinct cutting surfaces 136 and 138 of the reciprocating plate 14 may be further considered to have been defined at least in part by the inside surface 140 (not shown) of at least that portion of the cavity 22 (not shown) of the monolithic base plate 12 (not shown) into which the grooves 34 extend, i.e., by the inside surface 140 (not shown) of at least that portion of the cavity 22 (not shown) that “wraps around” the grooves 34 of the reciprocating plate 14. In some embodiments, the reciprocating plate 14 includes at least one tab or stand-off 36 disposed proximate or along the second end 32. In some embodiments, the reciprocating plate 14 includes at least one protrusion or post or stand-off 36 extending towards the monolithic base plate 12 (not shown). As discussed in FIG. 1, although not shown, the grooming device 10 includes a reciprocating mechanism operatively coupled to and configured for reciprocating the reciprocating plate 14 as is well known in the art. In some embodiments, the reciprocating mechanism is operatively coupled to the reciprocating plate 14. In some embodiments, the reciprocating mechanism is operatively coupled to the biasing mechanism 16 which is coupled to the reciprocating plate 14. In some embodiments, the at least two distinct cutting surfaces 136 and 138 of the reciprocating plate 14 are not pressed against the monolithic base plate 12 (not shown). Instead, in some embodiments, pressure on the monolithic base plate is in a direction substantially parallel to cutting reciprocating plate 14, substantially in the direction of the cavity 22 (not shown). In some embodiments, the direction of pressure is substantially tangential to the cutting surfaces 136 and 138. In some embodiments, if a portion of skin were to enter through the grooves 26 of the monolithic base plate 12 and come into contact with the grooves 34 of the reciprocating plate 14, this different direction of pressure may allow for the reciprocating plate 14 to be pressed away from the cutting surfaces 136 and 138. In some embodiments, this may retract the reciprocating plate 14 from shearing a hair shaft, but in an aspect of the present disclosure may also reduce and/or eliminate scrapes, cuts, and/or razor burn on sensitive, loose, and/or bumpy skin.

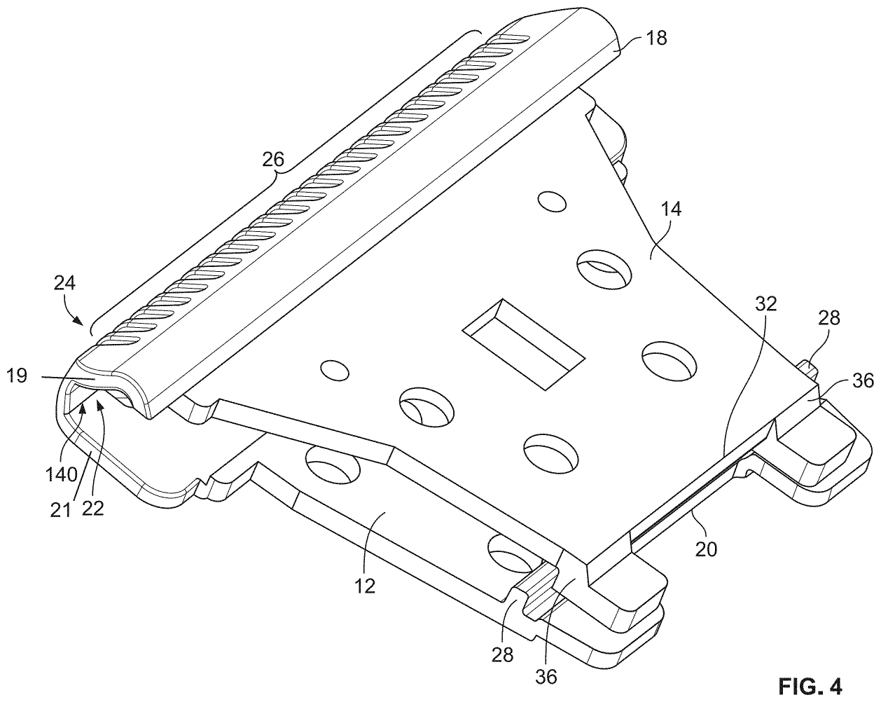

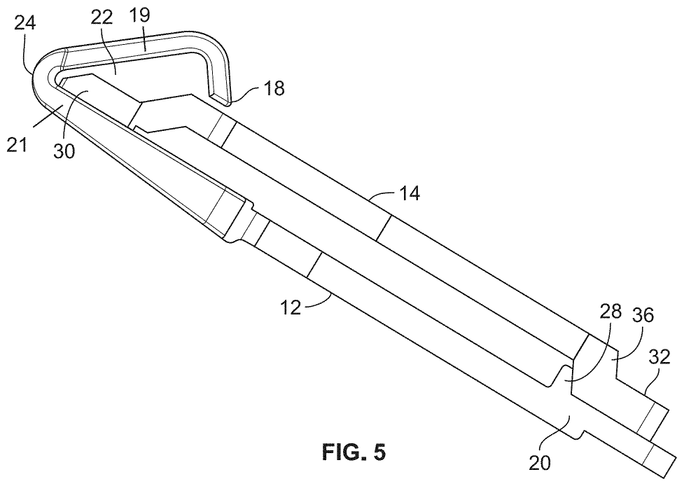

FIGS. 4 and 5, respectively, are perspective and side views illustrating the monolithic base plate 12 and the reciprocating plate 14 coupled to each other. In some embodiments, the monolithic base plate 12 is defined at least in part by opposing first end 18 and second end 20, respectively, a first portion 19, a second portion 21, and an arcuate section 24. In some embodiments, the first portion 19 extends from the first end 18 to the arcuate section 24. In some embodiments, the second portion 21 extends from the second end 20 to the arcuate section 24. In some embodiments, the first portion 19, the arcuate section 24, and the second portion 21 together define a cavity 22. In some embodiments, the reciprocating plate 14 may be further considered to have been defined at least in part by an inside surface 140. In some embodiments, grooves 26 along the arcuate section 24 are configured for directing or routing hair protruding into or extending through the grooves 26 to or into the grooves 34 of the reciprocating plate 14. In some embodiments, the monolithic base plate 12 includes a cavity 22 defined at least in part by an arcuate section 24 proximate the first end 18. In some embodiments, the reciprocating plate 14 includes a first end 30 of the reciprocating plate 14 and at least one tab or stand-off 36 disposed proximate or along the second end 32. In some embodiments, at least a portion of the reciprocating plate 14 proximate the second end 32 thereof is in sliding abutment with or in close proximity to at least a portion of the rail 28 disposed proximate the second end 20 of the monolithic base plate 12.

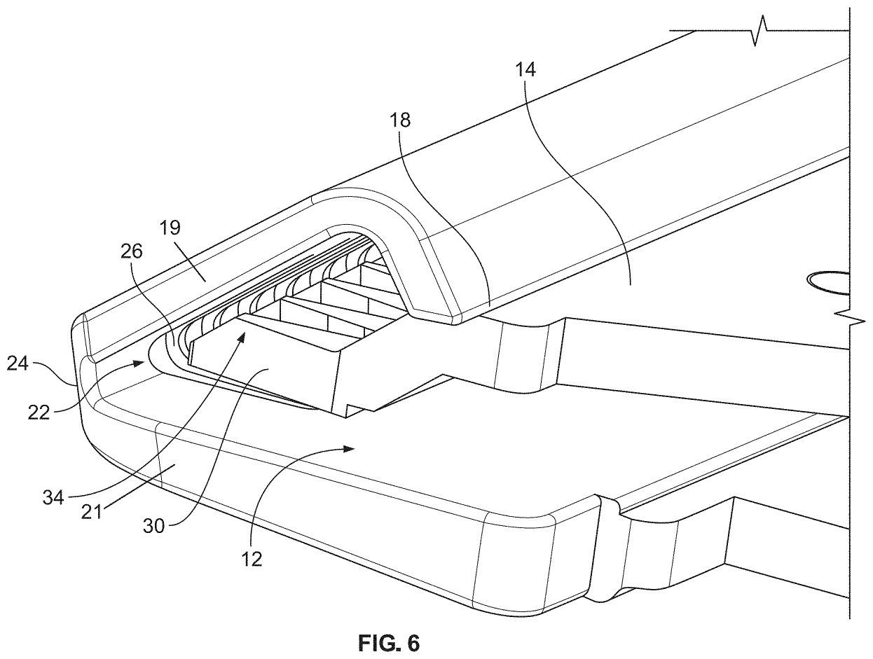

FIG. 6 is a close-up perspective view illustrating the grooves 34 on the first end 30 of the reciprocating plate 14 extending into the cavity 22 of the monolithic base plate 12. In some embodiments, the monolithic base plate 12 is defined at least in part by opposing first end 18 and second end 20 (not shown), respectively, a first portion 19, a second portion 21, and an arcuate section 24. In some embodiments, the first portion 19 extends from the first end 18 to the arcuate section 24. In some embodiments, the second portion 21 extends from the second end 20 (not shown) to the arcuate section 24. In some embodiments, the first portion 19, the arcuate section 24, and the second portion 21 together define a cavity 22. In some embodiments, the monolithic base plate 12 includes a cavity 22 defined at least in part by an arcuate section 24 proximate the first end 18. In some embodiments, the grooves 26 along the arcuate section 24 are configured for directing or routing hair protruding into or extending through the grooves 26 to or into the grooves 34 of the reciprocating plate 14. In some embodiments, the grooves 34 of the reciprocating plate 14 are configured as cutting edges for shearing or cutting hair protruding or extending through the grooves 26 of the monolithic base plate 12. As such, in some embodiments, the cutting edges will shear or cut hair protruding into or extending through the grooves 26 from either side of the grooves 34 of the reciprocating plate 14. Accordingly, in some embodiments, the reciprocating plate 14 is considered having at least two distinct cutting surfaces 136 and 138 (not shown) defined at least in part by the grooves 34 configured as cutting edges. In some embodiments, it will be appreciated that the at least two distinct cutting surfaces 136 and 138 of the reciprocating plate 14 may be further considered to have been defined at least in part by the inside surface 140 of at least the portion of the cavity 22 that “wraps around” the grooves 34 (not shown) of the reciprocating plate 14.

In some embodiments, the grooves 34 of the reciprocating plate 14 are in sliding abutment with or in close proximity to at least a portion of the cavity 22. In some embodiments, the grooves 34 of the reciprocating plate 14 are in sliding abutment with or in close proximity to at least a portion of the grooves 26 disposed along the arcuate section 24 of the monolithic base plate 12.

In some embodiments, at least a portion of the reciprocating plate 14 proximate the second end 32 thereof is in sliding abutment with or in close proximity to at least a portion of the monolithic base plate 12 proximate the second end 20 thereof. As such, the monolithic base plate 12 and the reciprocating plate 14 are configured to ensure that the reciprocating plate 14 reciprocates primarily in the transverse direction. The coupling of the monolithic base plate 12 and the reciprocating plate 14 proximate their respective second ends 20 and 32 inhibits substantial movement of the reciprocating plate 14 towards and away from the cavity 22. Additionally, the coupling of the monolithic base plate 12 and the reciprocating plate 14 proximate their respective second ends 20 and 34 inhibits substantial rotation of the reciprocating plate 14 about an axis extending orthogonally through the reciprocating plate 14 and also about an axis orthogonal to the transverse direction or width of the reciprocating plate 14 and extending along a plane of the reciprocating plate 14. In other words, the monolithic base plate 12 and the reciprocating plate 14 are coupled for inhibiting substantial roll and yaw of the reciprocating plate 14.

In some embodiments, the reciprocating plate 14 includes at least one protrusion or post or stand-off 36 (not shown) extending towards the monolithic base plate 12. In some embodiments, the at least one protrusion 36 (not shown) is configured for slidably coupling with at least a portion of the monolithic base plate 12. In some embodiments, the monolithic base plate 12 includes complementary openings or slots or channels (not shown) for receiving at least a portion of the at least one protrusion 36 (not shown). As such, the monolithic base plate 12 and the reciprocating plate 14 are configured for substantially inhibiting both roll and yaw of the reciprocating plate 14.

In some embodiments, the biasing mechanism 16 is configured for applying sufficient pressure or force on the reciprocating plate 14 for retaining the grooves 34 within and in sliding abutment with or in close proximity to the cavity 22. In some embodiments, the biasing mechanism 16 includes a biasing plate 40 coupled to the reciprocating plate 14 and at least one biasing element 42 configured for applying the pressure or force on the biasing plate 40 for retaining the grooves 34 within and in sliding abutment with or in close proximity to the cavity 22. In some embodiments, the biasing mechanism 16 is configured as an anti-lift mechanism for substantially inhibiting the displacement of the reciprocating plate 14 away from the monolithic base plate 12. In some embodiments, the biasing mechanism 16 is configured as a “shock absorber”.

As used herein, “anti-lift mechanism” means the first end 18 of the monolithic base plate 12 prevents the reciprocating plate 14 from substantially lifting away from the second portion 21 of the monolithic base plate 12.

As used herein, “prevents” refers to reducing the probability of the reciprocating plate 14 from lifting away from the second portion 21 of the monolithic base plate 12.

As used herein, “substantially lifting away” refers to the reciprocating plate 14 moving more than about 1 millimeter away from the second portion 21 of the monolithic base plate 12. In some embodiments, the distance between the first end 18 of the monolithic base plate 12 and the reciprocating plate 14 may be equal to or less than about 1 millimeters (mm), or equal to or less than about 0.9 mm, or equal to or less than about 0.8 mm, or equal to or less than about 0.7 mm, or equal to or less than about 0.6 mm, or equal to or less than about 0.5 mm, or equal to or less than about 0.4 mm, or equal to or less than about 0.3 mm, or equal to or less than about 0.2 mm, or equal to or less than about 0.1 mm

In some embodiments, the monolithic base plate 12 includes a tab or an overhang 44 extending away from the first end 18. In some embodiments, the tab or overhang 44 is in sliding abutment with or in close proximity to the reciprocating plate 14. In some embodiments, the tab or overhang 44 is configured as an anti-lift mechanism. As such, the tab or overhang 44 is configured for inhibiting substantial displacement of the reciprocating plate 14 in a direction away from and/or towards the monolithic base plate 12. Accordingly, the grooming device will not include a biasing mechanism such as, for example, the biasing mechanism 16.

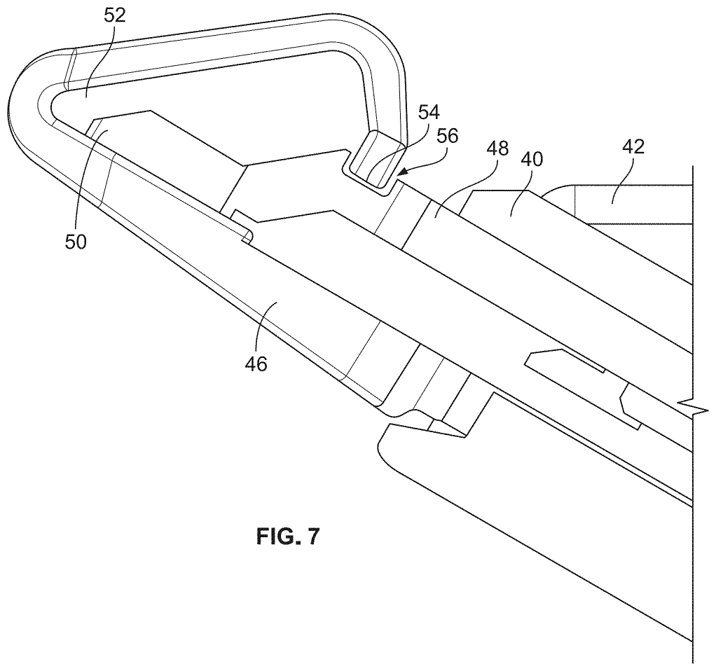

FIG. 7 illustrates a non-limiting exemplary embodiment of a monolithic base plate 46 and a reciprocating plate 48 configured for sliding abutment with or in close proximity to each other. In some embodiments, the reciprocating plate 48 includes a plurality of grooves along at least a portion of a first end 50, e.g., grooves 34 (not shown), extending into a cavity 52, e.g., cavity 22, of the monolithic base plate 46. In some embodiments, the monolithic base plate 46 includes a first end 54 extending into and in sliding abutment with or in close proximity to a channel or slot 56 in the reciprocating plate 48. In some embodiments, at least one surface of the first end 54 extending into the channel or slot 56 are in close proximity to at least one surface of the channel or slot 56. Accordingly, the monolithic base plate 46 and the reciprocating plate 48 are configured for substantially inhibiting both roll and yaw of the reciprocating plate 48, and for substantially inhibiting displacement of the grooved first end 50 into and out of the cavity 52. In some embodiments, the first end 54 extending into the channel or slot 56 at least partially aids in retaining the grooved first end 50 within and in sliding abutment with or in close proximity to the cavity 52. As such, the biasing plate 40 and the at least one biasing element 42, i.e., the biasing mechanism 16, will not be provided. In some embodiments, the channel or slot may be used to couple attachments to the grooming device.

In some embodiments, one or both the first end 54 of the monolithic base plate 46 and the channel or slot 56 in the reciprocating plate 48 extend the entire transverse width of the respective plates 46 and 48. In some embodiments, one or both the first end 54 of the monolithic base plate 46 and the channel or slot 56 in the reciprocating plate 48 extend a portion of the transverse width of the respective plates 46 and 48. For instance, in some embodiments, the first end 54 of the monolithic base plate 46 is configured as at least one tab or overhang and the channel or slot 56 in the reciprocating plate 48 extends the entire transverse width thereof. In some embodiments, the first end 54 of the monolithic base plate 46 is configured as at least one tab or overhang and the channel or slot 56 is configured as a plurality of channels or slots, wherein each channel or slot is configured to receive one of the plurality of tabs or overhangs. Of course, each channel or slot will be of sufficient width for unhindered displacement of the reciprocating plate 48.

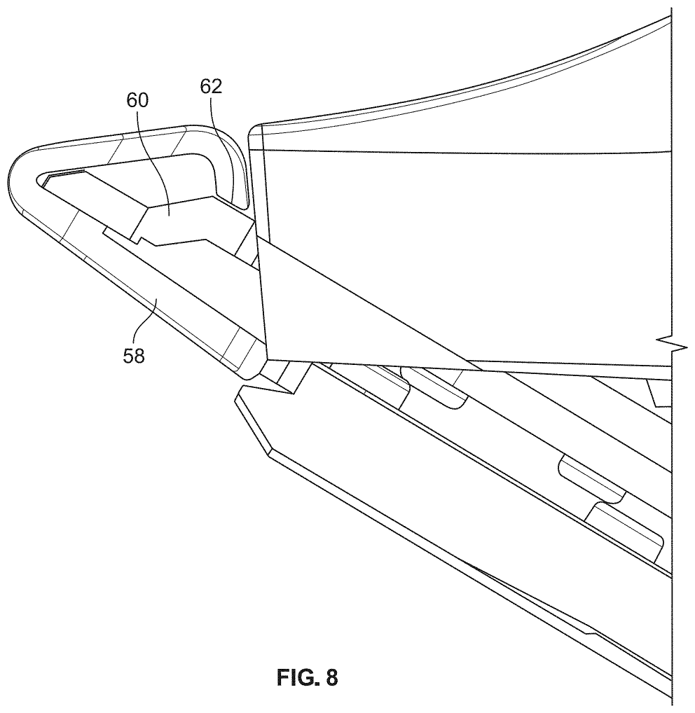

FIG. 8 illustrates another non-limiting exemplary embodiment of a monolithic base plate 58 and a reciprocating plate 60 configured for sliding abutment with or in close proximity to each other. In several aspects, the monolithic base plate 58 is substantially similar to the monolithic base plate 46 (depicted in FIG. 7) and the reciprocating plate 60 is substantially similar to the reciprocating plate 48. One difference between the reciprocating plates 60 and 48 (depicted in FIG. 7) is that the reciprocating plate 60 does not include at least one channel or slot such as channel or slot 56 (depicted in FIG. 7) for receiving the first end 62 of the monolithic base plate 58. In some embodiments, the first end 62 of the monolithic base plate 58 is in sliding abutment with or in close proximity to the reciprocating plate 60. In some embodiments, the first end 62 extends the entire transverse width of the monolithic base plate 58. In some embodiments, the first end 62 is configured as at least one tab or overhang in sliding abutment with or in close proximity to the reciprocating plate 60.

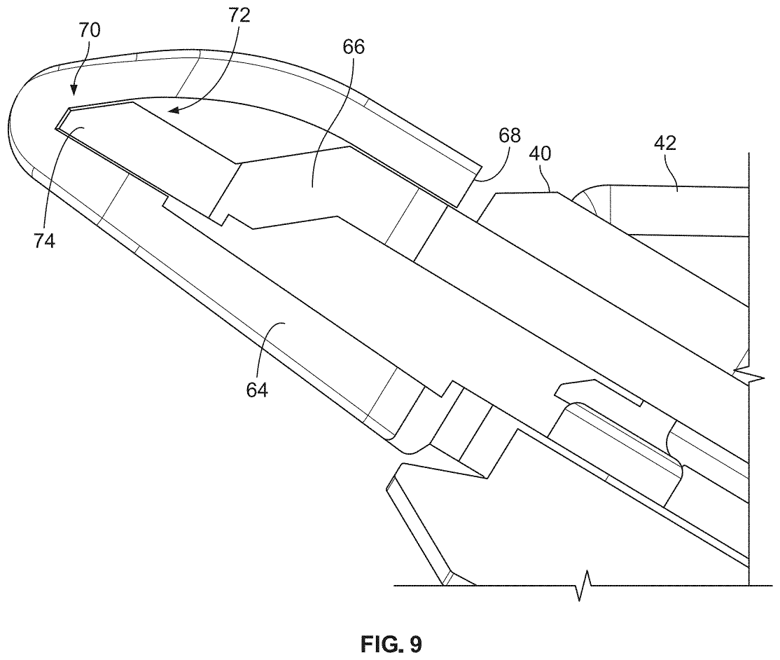

FIG. 9 illustrates yet another non-limiting exemplary embodiment of a monolithic base plate 64 and a reciprocating plate 66 configured for sliding abutment with or in close proximity to each other. In some embodiments, the first end 68 of the monolithic base plate 64 extends over and is in sliding abutment with or in close proximity to the reciprocating plate 66. In some embodiments, the first end 68 extends the entire transverse width of the monolithic base plate 64. In some embodiments, the first end 68 is configured as at least one tab or overhang in sliding abutment with or in close proximity to the reciprocating plate 66. In some embodiments, an inside surface 70 of the cavity 72 of the monolithic base plate 64 and the grooved first end 74 of the reciprocating plate 66 have complementary geometries or profiles. In some embodiments, the biasing mechanism 16 (not shown) includes a biasing plate 40 coupled to the reciprocating plate 66 and at least one biasing element 42 configured for applying the pressure or force on the biasing plate 40 for retaining the grooves 34 (not shown) within and in sliding abutment with or in close proximity to an inside surface 70 of the cavity 72.

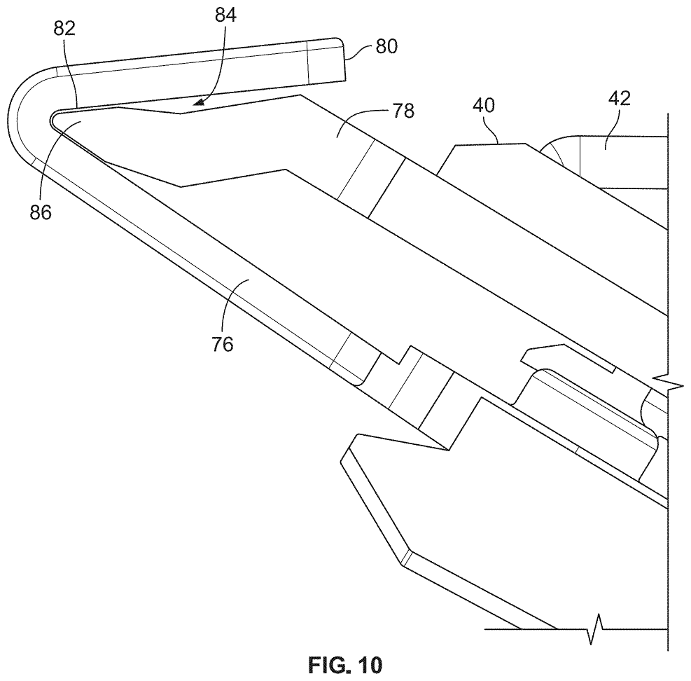

FIG. 10 illustrates another non-limiting exemplary embodiment of a monolithic base plate 76 and a reciprocating plate 78 configured for sliding abutment with or in close proximity to each other. In some embodiments, the first end 80 of the monolithic base plate 76 is not in sliding abutment with or in close proximity to the reciprocating plate 78. In some embodiments, an inside surface 82 of the cavity 84 of the monolithic base plate 76 and the grooved first end 86 of the reciprocating plate 78 have complementary geometries or profiles. In some embodiments, the biasing mechanism 16 (not shown) includes a biasing plate 40 coupled to the reciprocating plate 78 and at least one biasing element 42 configured for applying the pressure or force on the biasing plate 40 for retaining the grooves 34 (not shown) within and in sliding abutment with or in close proximity to an inside surface 82 of the cavity 84.

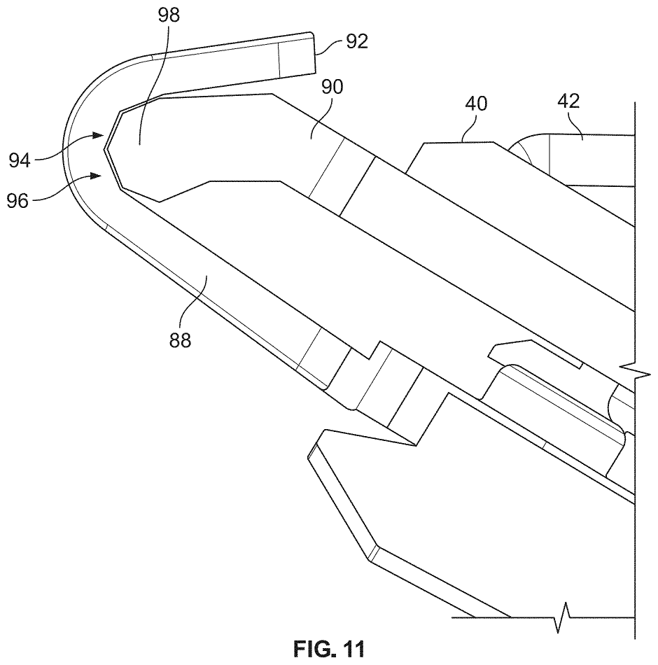

FIG. 11 illustrates yet another non-limiting exemplary embodiment of a monolithic base plate 88 and a reciprocating plate 90 configured for sliding abutment with or in close proximity to each other. In some embodiments, the first end 92 of the monolithic base plate 88 is not in sliding abutment with or in close proximity to the reciprocating plate 90. In some embodiments, an inside surface 94 of the cavity 96 of the monolithic base plate 88 and the grooved first end 98 of the reciprocating plate 90 have complementary geometries or profiles. In some embodiments, the biasing mechanism 16 (not shown) includes a biasing plate 40 coupled to the reciprocating plate 90 and at least one biasing element 42 configured for applying the pressure or force on the biasing plate 40 for retaining the grooves 34 (not shown) within and in sliding abutment with or in close proximity to an inside surface 94 of the cavity 96.

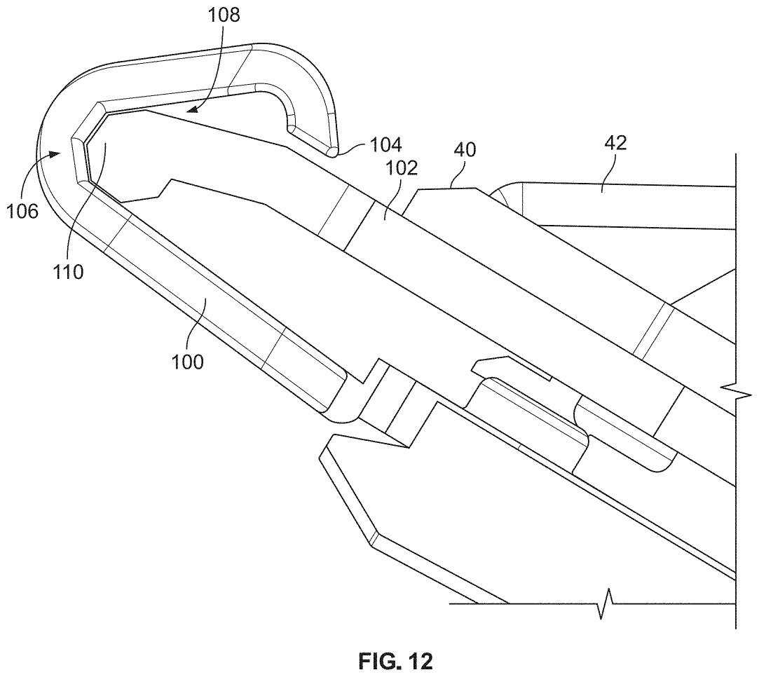

FIG. 12 illustrates another non-limiting exemplary embodiment of a monolithic base plate 100 and a reciprocating plate 102 configured for sliding abutment with or in close proximity to each other. In several aspects, the monolithic base plate 100 is substantially similar to the monolithic base plate 88 (FIG. 11) and the reciprocating plate 102 is substantially similar to the reciprocating plate 90 (FIG. 11). In some embodiments, the first end 104 of the monolithic base plate 100 extends “over” or “above”, i.e., does not contact, the reciprocating plate 102. In some embodiments, the first end 104 is in sliding abutment with or in close proximity to the reciprocating plate 102. In some embodiments, the first end 104 extends the entire transverse width of the monolithic base plate 100. In some embodiments, the first end 104 is configured as at least one tab or overhang. In some embodiments, an inside surface 106 of the cavity 108 of the monolithic base plate 100 and the grooved first end 110 of the reciprocating plate 102 have complementary geometries or profiles. In some embodiments, the biasing mechanism 16 (not shown) includes a biasing plate 40 coupled to the reciprocating plate 102 and at least one biasing element 42 configured for applying the pressure or force on the biasing plate 40 for retaining the grooves 34 (not shown) within and in sliding abutment with or in close proximity to an inside surface 106 of the cavity 108.

In some embodiments, the at least one first end 18, 54, 62, 68, 80, 92, and 104 are configured as an anti-lift mechanism for substantially inhibiting the displacement of the reciprocating plate 14 away from the monolithic base plate 12.

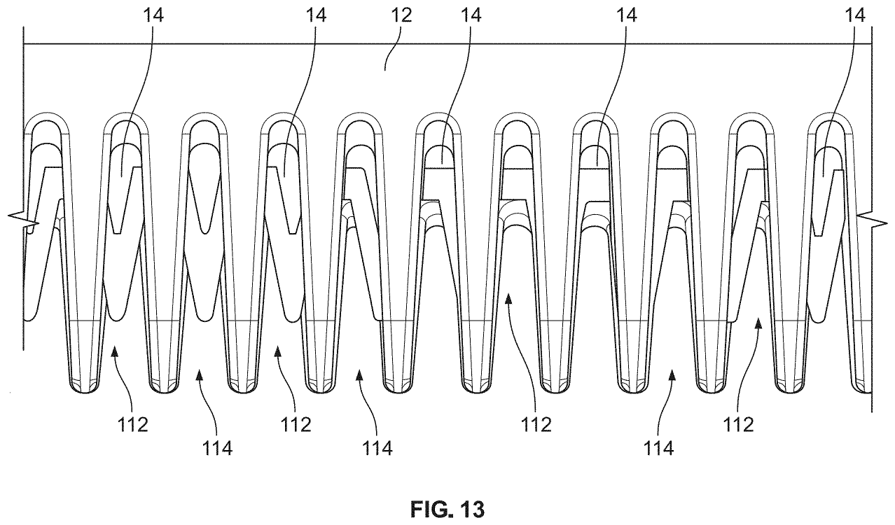

FIG. 13 is a non-limiting exemplary illustration of a grooved first end 112 of a reciprocating plate 14 extended into a cavity 114 of a monolithic base plate 12.

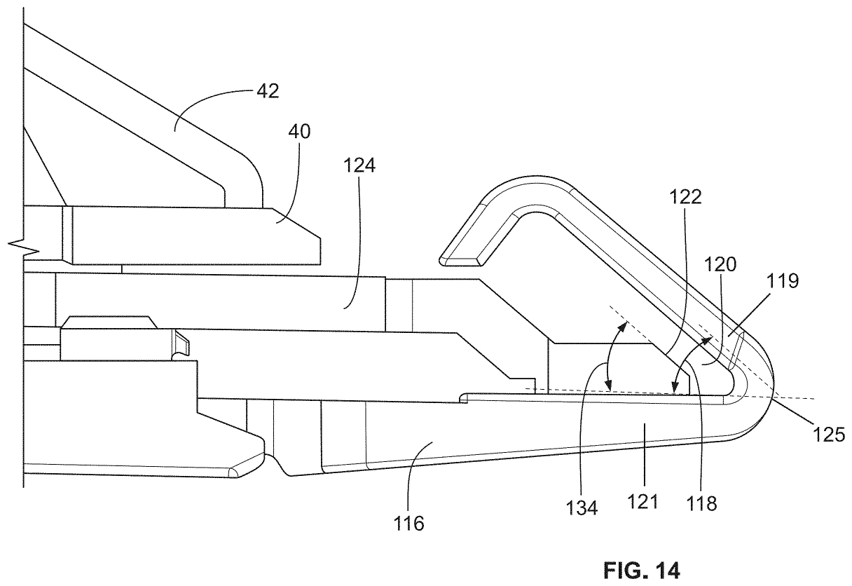

FIG. 14 illustrates a non-limiting exemplary embodiment of an angle 118 of the cavity 120 of the monolithic base plate 116. In some embodiments, the angle 118 of the cavity 120 is an acute angle. In some embodiments, the angle 118 of the cavity 120 is greater than or equal to zero degrees and less than or equal to ninety degrees. In some embodiments, the angle 118 of the cavity 120 is greater than zero (0) degrees and less than ninety (90) degrees. In some embodiments, the angle 118 is between approximately thirty-five (35) degrees and approximately fifty-five (55) degrees. In some embodiments, the angle 118 is between approximately forty (40) degrees and approximately fifty (50) degrees. In some embodiments, the angle 118 is approximately forty-five (45) degrees. In some embodiments, the first portion 119, the arcuate section 125, and the second portion 121 together may allow for bumpy or irregular patches of skin, or loose skin, to remain outside the cavity 120 of the monolithic base plate 116 while permitting hair shafts growing from such a patch of skin to be sheared and/or cut by the reciprocating plate 124. In some embodiments, the first portion 119, the arcuate section 125, and the second portion 121 together allow the user to approach hair shafts from different angles. In some embodiments, the biasing mechanism 16 (not shown) includes a biasing plate 40 coupled to the reciprocating plate 124 and at least one biasing element 42 configured for applying the pressure or force on the biasing plate 40 for retaining the grooves 34 (not shown) within and in sliding abutment with or in close proximity to the cavity 120.

FIG. 14 additionally illustrates a non-limiting exemplary embodiment of an angle 134 of the grooved first end 122 of the reciprocating plate 124. In some embodiments, the angle 134 of the grooved first end 122 is an acute angle. In some embodiments, the angle 134 of the grooved first end 122 is greater than or equal to zero degrees and less than or equal to ninety degrees. In some embodiments, the angle 134 of the grooved first end is 122 is greater than zero (0) degrees and less than ninety (90) degrees. In some embodiments, the angle 134 is between approximately thirty-five (35) degrees and approximately fifty-five (55) degrees. In some embodiments, the angle 134 is between approximately forty (40) degrees and approximately fifty (50) degrees. In some embodiments, the angle 134 is approximately forty-five (45) degrees. In some embodiments, an angle 134 of the grooved first end 122 of the reciprocating plate 124 is substantially the same as or approximately equal to the angle 118 of the cavity 120.

In some embodiments, as described in the foregoing, the first end 18 of the monolithic base plate 12 is in sliding abutment with or in close proximity to a surface of or the channel or slot 56 in the reciprocating plate 14. As such, the monolithic base plate 12 and the reciprocating plate 14 are configured for inhibiting ingress of skin through the interface between the first end 18 and the reciprocating plate 14.

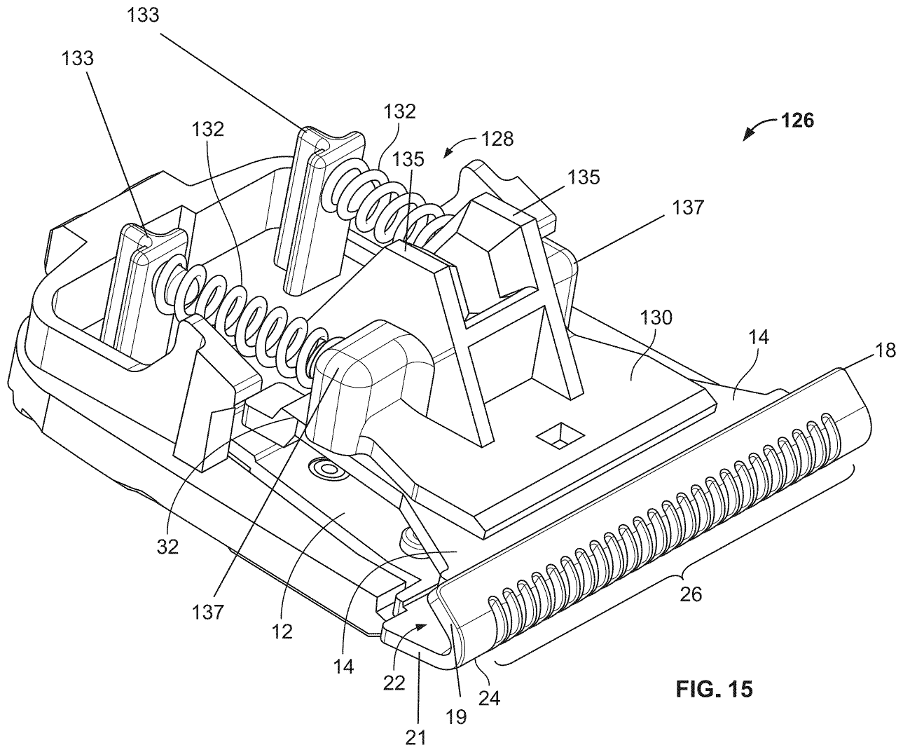

FIG. 15 is a perspective view of non-liming exemplary embodiments of some of the primary components inside an alternate embodiment of a grooming device 126 of the instant disclosure. In some embodiments, the grooming device 126 includes the monolithic base plate 12, the reciprocating plate 14, and a biasing mechanism 128. In some embodiments, the reciprocating plate 14 is defined at least in part by opposing first end 30 (not shown) and second end 32. In some embodiments, the monolithic base plate 12 is defined at least in part by opposing first end 18 and second end 20 (not shown), respectively, a first portion 19, a second portion 21, and an arcuate section 24. In some embodiments, the first portion 19, the arcuate section 24, and the second portion 21 together define a cavity 22. In some embodiments, the monolithic base plate 12 includes a plurality of grooves 26 disposed along at least a portion of the arcuate section 24. In some embodiments, one difference between the grooming devices 10 and 126 is that the biasing mechanism 128 is configured somewhat differently than the biasing mechanism 16. In all other aspects, the various embodiments of the monolithic base plates and of the reciprocating plates detailed in the foregoing as they related to the grooming device 10 are equally applicable for the grooming device 126. This includes, but is not limited to, the interface between the first end 18 of the monolithic base plate 12 and the reciprocating plate 14.

In some embodiments, the biasing mechanism 128 is configured for applying sufficient pressure or force on the reciprocating plate of the grooming device 126 for retaining the grooved first end of the reciprocating plate within and in sliding abutment with or in close proximity to the cavity of the monolithic base plate. In some embodiments, the biasing mechanism 128 includes a biasing plate 130 coupled to the reciprocating plate and at least one biasing element 132 configured for applying the pressure or force on the biasing plate 130 for retaining the grooved first end of the reciprocating plate within and in sliding abutment with or in close proximity to the cavity of the monolithic base plate. In some embodiments, the at least one biasing element 132 is a spring. In some embodiments, the at least one biasing element 132 is compressed between a first set of blocks 133 and a second set of blocks 137. In some embodiments, the first set of blocks 133 are coupled to the second end of the reciprocating plate 32 while a second set of blocks 137 are coupled to the biasing plate 130. In some embodiments, the biasing plate 130 is coupled to the second end 32 of the reciprocating plate 14.

In some embodiments, blocks the second set of blocks 137 are also coupled to adapter plates 135. In some embodiments, the adapter plates 135 are coupled to a mechanism in the grooming device that provides movement of the reciprocating plate 14 with respect to embodiment of the present disclosure, the movement of the reciprocating plate 14 is an oscillating motion; however, the present disclosure is not limited to such a motion. Other types of motion, e.g., vibratory, circular, etc., are possible without departing from the scope of the present disclosure.

As described in the foregoing with reference to the grooming device 10, some embodiments of the grooming device 126 do not include a biasing mechanism such as, for example, the biasing mechanism 128.

In view thereof, modified and/or alternate configurations of the non-limiting exemplary embodiments illustrated and described herein may become apparent or obvious to one of ordinary skill. All such variations are considered as being within the metes and bounds of the instant disclosure. For instance, while reference may have been made to particular feature(s) and/or function(s), this disclosure is considered to also encompass any and all equivalents providing functionalities similar to those described herein with reference to the accompanying drawings. Accordingly, the spirit, scope and intent of the instant disclosure embraces all variations.

1. A grooming device, comprising:
a monolithic base plate, comprising:
opposing first end and a second end;
a first portion;
a second portion; and
an arcuate section;
wherein the first portion extends from the first end to the arcuate section;
wherein the second portion extends from the second end to the arcuate section;
wherein the first portion, the arcuate section, and the second portion together define a cavity;
wherein the cavity is defined at least in part by an arcuate section of the monolithic base plate proximate the first end thereof; and
wherein the arcuate section has an angle of the cavity greater than zero degrees and less than ninety degrees;
a plurality of grooves disposed along at least a portion of the arcuate section;
a reciprocating plate, comprising:
a first end of the reciprocating plate comprising a plurality of grooves extending into the cavity of the monolithic base plate; and
a second end of the reciprocating plate opposite the first end of the reciprocating plate; and
a reciprocating mechanism operatively coupled to the second end of the reciprocating plate;
wherein the first end of the monolithic base plate is configured as an anti-lift mechanism that prevents the reciprocating plate from substantially lifting away from the second portion of the monolithic base plate.

2. The grooming device of claim 1, wherein the grooves in the monolithic base plate are configured to guide hair into the grooves of the reciprocating plate.

3. The grooming device of claim 2, wherein the grooves of the reciprocating plate are configured as cutting edges.

4. The grooming device of claim 3, wherein the cutting edges of the reciprocating plate define at least two distinct cutting surfaces.

5. The grooming device of claim 4, wherein the cutting edges shear hair protruding through the grooves from either side of the monolithic base plate.

6. The grooming device of claim 4, wherein at least a portion of the at least two distinct cutting surfaces extends into the grooves of the monolithic base plate.

7. The grooming device of claim 1, wherein an inside surface of the cavity and the first end of the reciprocating plate have complementary geometries.

8. The grooming device of claim 1, wherein the angle of the cavity is between approximately thirty-five degrees and approximately fifty-five degrees.

9. The grooming device of claim 8, wherein the angle of the cavity is between approximately forty degrees and approximately fifty degrees.

10. The grooming device of claim 9, wherein the angle of the cavity is approximately forty-five degrees.

11. The grooming device of claim 1, wherein an angle of an inside surface of the cavity and an angle of the first end of the reciprocating plate are substantially equal.

12. The grooming device of claim 1, wherein the first end of the monolithic base plate is configured as an anti-lift mechanism.

13. The grooming device of claim 1, wherein the first end of the monolithic base plate is in sliding abutment with the reciprocating plate.

14. The grooming device of claim 1, wherein the reciprocating plate comprises a channel for receiving at least a portion of the first end of the monolithic base plate.

15. The grooming device of claim 14, wherein the first end of the monolithic base plate and the channel in the reciprocating plate are in sliding engagement with each other.

16. The grooming device of claim 15, wherein the first end of the monolithic base plate and the channel in the reciprocating plate are configured to inhibit rotation of the reciprocating plate.

17. The grooming device of claim 1, wherein at least a portion of the second end of the monolithic base plate and at least a portion of the second end of the reciprocating plate are in sliding abutment with each other.

18. The grooming device of claim 17, wherein the monolithic base plate and the reciprocating plate comprise:
opposing surfaces; and
complementary protrusions extending from at least a portion of each opposing surface, wherein the protrusions are disposed in sliding abutment with each other.

19. The grooming device of claim 18, wherein the complementary protrusions are configured to inhibit rotation of the reciprocating plate

20. A grooming device, comprising:
a monolithic base plate 12, comprising:
opposing first end and second end;
a first portion;
a second portion;
an arcuate section;
wherein the first portion extends from the first end to the arcuate section;
wherein the second portion extends from the second end to the arcuate section;
wherein the first portion, the arcuate section, and the second portion together define a cavity;
wherein the cavity is defined at least in part by an arcuate section of monolithic base plate proximate the first end thereof; and
wherein the arcuate section has an angle of the cavity greater than zero degrees and less than ninety degrees;
a plurality of grooves disposed along at least a portion of the arcuate section;
a reciprocating plate comprising:
a first end of the reciprocating plate comprising a plurality of grooves extending into the cavity of the monolithic base plate; and
a second end of the reciprocating plate opposite the first end of the reciprocating plate;
a biasing mechanism configured for retaining the first end of the reciprocating plate in sliding abutment within the cavity of the monolithic base plate; and
a reciprocating mechanism operatively coupled to the reciprocating plate;
wherein the first end of the monolithic base plate is configured as an anti-lift mechanism that prevents the reciprocating plate from substantially lifting away from the second portion of the monolithic base plate.

21. The grooming device of claim 20, wherein the biasing mechanism comprises:
at least one biasing element; and
a biasing plate coupled to the reciprocating plate.

22. The grooming device of claim 20, wherein the biasing mechanism is configured as an anti-lift mechanism.

23. The grooming device of claim 20, wherein the first end of the base plate is configured as an anti-lift mechanism.
